(19) United States
(12) Patent Application Publication
(10) Pub. No.: US 2009/0109337 A1
(43) Pub. Date: Apr. 30, 2009

(54) VIDEO DISPLAY APPARATUS AND VIDEO DISPLAY METHOD

(75) Inventors: Junichi Imai, Saitama (JP); Masahiro Okamura, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Tokyo (JP)

(21) Appl. No.: 12/294,544

(22) PCT Filed: Mar. 27, 2007
(86) PCT No.: PCT/JP2007/056377

§ 371 Date: Sep. 25, 2008

(30) Foreign Application Priority Data
Mar. 27, 2006 (JP) 2006-085788

(51) Int. Cl. H04N 5/445; H04N 7/173; H04N 5/66

(52) U.S. Cl. 348/564; 725/109; 348/739; 348/E05.099; 348/E05.133

(57) ABSTRACT

A video display apparatus which can display only an arbitrary area of a Web page in an arbitrary size and at an arbitrary position on a main image. The video display apparatus which forms a single synthesis video image by synthesizing different video images has: Web page obtaining means for obtaining the Web page through a network; data converting means for converting the Web page into image data; extracting means for extracting a designated area from the Web page converted into the image data; display size setting means for setting a Web page image of the designated area to a designated display size; and display position setting means for setting a display position of the Web page image of the designated area, wherein a video signal synthesizing means forms a synthesized video signal on the basis of the designated display size setting and the display position.

### TECHNICAL FIELD

The present invention relates to a video display apparatus and a video display method for simultaneously displaying a main video image displaying a television video image or the like and a video image of an arbitrary portion of a Web page.

### BACKGROUND ART

In recent years, among video display apparatuses such as a television receiver, apparatuses are known which are capable of displaying on a display screen a video image of a television broadcasting and a Web page received through a network such as the Internet. The simultaneous display of those image is enabled by adopting a dual-screen display for displaying the video image of the television broadcasting and the Web page onto the display screen in a parallel manner. With this type of feature, users have gained the way to obtain further detailed information from the Web page on the Internet with respect to contents broadcasted by a television program and can obtain every information opened on the Internet such as weather forecast and stock price information while viewing the television program.

Japanese Patent Kokai No. 11-136593 (Patent Document 1) discloses means for simultaneously displaying the video image of the television broadcasting and the image of the Web page on the Internet.

Japanese Patent Kokai No. 2003-319174 (Patent Document 2) and Japanese Patent kohyo No. 2002-524791 (Patent Document 3) disclose means for extracting a constructing portion of the Web page and enlarging a part of a character train and means for extracting designated portions from a plurality of Web pages and reconstructing to a single constructing file.

Patent Document 1: Japanese Patent Kokai No. 11-136593

Patent Document 2: Japanese Patent Kokai No. 2003-319174

Patent Document 3: Japanese Patent Kohyo No. 2002-524791

### DISCLOSURE OF THE INVENTION

### Problem to be Solved by the Invention

Many of Web pages in the Internet include not only a contents portion comprising a plurality of images, characters, diagrams, tables, and the like but also an advertisement portion, links to other Web sites, and the like. There are cases where the user does not always need all of those contents. Displaying the Web page including all of those contents on the display screen simultaneously with the television video image, desired information is displayed small and the whole display screen is complicated. Since the display screen which displays the TV video image and the display screen which displays the Web page are simultaneously displayed to the right and left in parallel, there is also such a problem that both images are reduced and displayed and it becomes hard to see.

Although the means for extracting a portion from the constructing portion of the Web page are disclosed in Patent Documents 2 and 3, as for a unit which can be extracted in both of the documents, the extraction is performed on units of a preset compositional element, that is, in tag units of an HTML document. Also in such cases, a possibility exists where unnecessary portions are included.

The invention has been made in consideration of the foregoing points and it is an object to provide a video display apparatus which can display only an arbitrary area of a Web page at an arbitrary position and in an arbitrary size simultaneously with a main image.

### Means for Solving the Problem

According to the invention, there is provided a video display apparatus comprising: first video signal generating means for generating a first video signal; second video signal generating means for generating a second video signal different from the first video signal; video signal synthesizing means for synthesizing the first video signal and the second video signal to generate a single synthesized video signal; and display means for reproducing and displaying any one of the first video signal, the second video signal, and the synthesized video signal, wherein the second video signal generating means includes Web page obtaining means, connected to a network, for obtaining a Web page through the network, data converting means for converting the Web page into image data, extracting means for extracting a designated area from the Web page converted into the image data, display size setting means for setting a Web page image in the designated area to a designated display size, and display position setting means for setting a display position of the Web page image in the designated area, and the video signal synthesizing means forms the synthesized video signal on the basis of the designated display size setting and the display position setting.

According to the invention, there is also provided a video display method comprising: a first video signal generating step of generating a first video signal; a second video signal generating step of generating a second video signal different from the first video signal; a video signal synthesizing step of synthesizing the first video signal and the second video signal to generate a single synthesized video signal; and a display step of reproducing and displaying any one of the first video signal, the second video signal, and the synthesized video signal, wherein the second video signal generating step includes a Web page obtaining step of obtaining a Web page through a network, a data converting step of converting the Web page into image data, an extracting step of extracting a designated area from the Web page converted into the image data, a display size setting step of setting a Web page image in the designated area to a designated display size, and a display position setting step of setting a display position of the Web page image in the designated area, and in the video signal synthesizing step, the synthesized video signal is formed on the basis of the designated display size setting and the display position setting.

### BRIEF DESCRIPTION OF THE DRAWINGS

FIG. 1 is a schematic constructional diagram of a video display apparatus according to an embodiment of the invention.

FIG. 2 is a diagram showing an example of a Web page designation display screen using a GUI according to the embodiment of the invention.

FIG. 3 is a diagram showing an example of a display area designation display screen using the GUI according to the embodiment of the invention.

FIG. 4 is a diagram showing an example of a display setting display screen using the GUI according to the embodiment of the invention.

FIG. 5 is a flowchart showing the operation of the video display apparatus according to the embodiment of the invention.

FIG. 6 is a diagram showing an example of a synthesis video image displayed on a monitor according to the embodiment of the invention.

FIG. 7 is a schematic structural diagram of a video display apparatus according to a second embodiment of the invention.

FIG. 8 is a flowchart showing the operation of the video display apparatus according to the second embodiment of the invention.

FIG. 9 is a schematic structural diagram of a video display apparatus according to a third embodiment of the invention.

FIG. 10 is a flowchart showing the operation of the video display apparatus according to the third embodiment of the invention.

FIG. 11 is a flowchart showing the operation of an update image forming part according to the third embodiment of the invention.

### BEST MODE FOR CARRYING OUT THE INVENTION

Embodiments of the invention will be described hereinafter with reference to the drawings. In the drawings which will be described hereinbelow, substantially the same or equivalent component elements and portions are designated by the same reference numerals.

### Embodiment 1

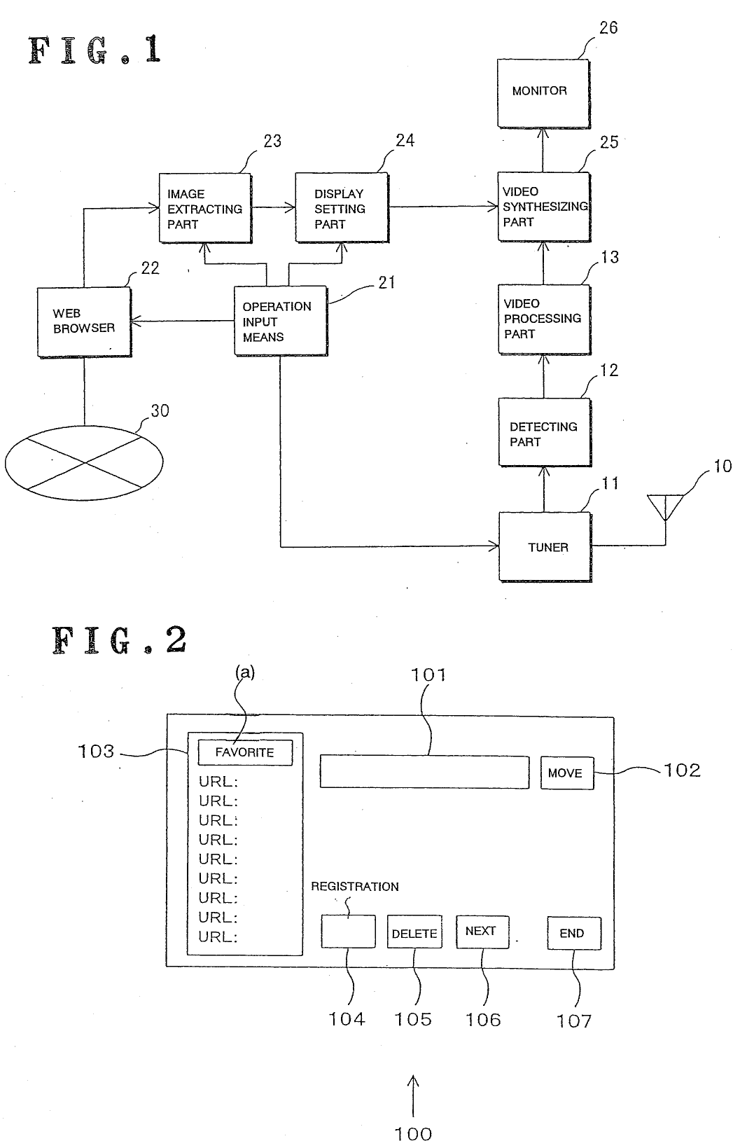

The first embodiment of the invention will be described with reference to FIGS. 1 to 6. FIG. 1 is a diagram showing a whole construction of a video display apparatus according to the first embodiment of the invention. When the user executes a station selecting operation by an operation of an operation input part 21, a tuner 11 selects a designated channel and receives a television radio wave of the channel through an antenna 10. A detecting part 12 frequency converts the received television radio wave signal (RF signal) into an intermediate frequency signal and, thereafter, detects the signal. A video processing part 13 separates a luminance signal, color difference signals, horizontal/vertical sync signals, and a color burst from the detected video signal and demodulates into RGB signals by a demodulating circuit (not shown). The demodulated video signal is supplied to a video synthesizing part 25.

The operation input means 21 is used for the user to execute various kinds of operations and executes: a station selection of a television broadcasting; a designation of the Web page to be browsed; a designation of an area of the Web page to be displayed onto a display screen of a monitor 26, which will be explained hereinafter; a designation of a display position; a designation of a display size; and the like. The operation input means 21 is provided by, for example, a remote controller, application software for executing various kinds of operations, or the like. The user executes those operation inputs by the remote controller, a pointing device such as a mouse, a keyboard (also including what is called a software keyboard for entering a key displayed on the monitor 26 by using the remote controller or the like), or the like.

A network 30 is a network such as Internet or Local Area Network (LAN) which can communicate data. In the embodiment, an explanation will be made on the assumption that the network 30 is the Internet. A Web browser 22 is an application for browsing the Web page and is used to download an HTML file or the like from the Internet on the basis of the URL designated by the user by the operation of the operation input means 21, analyze a layout, and display and reproduce characters, images, diagrams, tables, and the like included in the Web page.

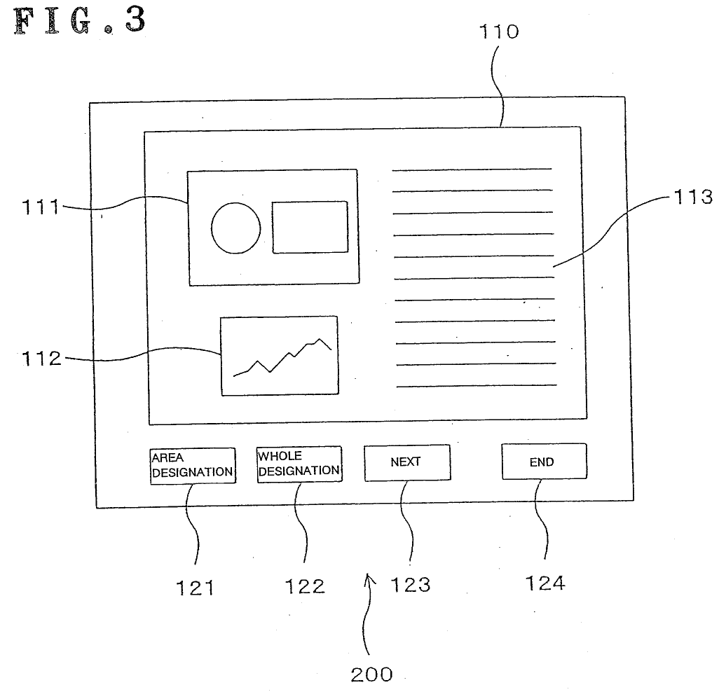

FIG. 2 is a diagram showing an example of a Web page designation display screen 100 using a GUI (Graphical User Interface) as operation input means 21 for allowing the user to select a desired Web page. The user enters the URL of the Web page to be browsed into a URL input part 101 by the keyboard operation or the like and clicks a move button 102 or selects a desired URL from a registered URL list 103, so that the designated Web page is downloaded. A registration button 104 is used to newly register a URL into the registered URL list 103. A delete button 105 is used to delete the unnecessary URL from the registered URL list 103. A “next” button 106 is used to shift to a process of an image extracting part 23, which will be described hereinafter. An end button 107 is used to finish the Web page designation display screen.

The image extracting part 23 converts the Web page obtained by the Web browser 22 into data of an image file format such as a bit map from the HTML format and extracts an area of the portion designated by the user from the Web page. The portion extracted by the process is finally displayed onto the monitor 26 together with the television video image. When the converting process of the Web page to the image data is executed, as shown in FIG. 3, a display area designation display screen 200 using the GUI as operation input means 21 which is used for the user to designate a display area is displayed onto the monitor 26 together with the Web page converted into the image file. Assuming that a downloaded Web page 110 is constructed by, for example, an image area 111, a chart area 112, and a character area 113, and if the user wants to display only the image area 111 in the Web page 110, he designates a display range in the image area 111 by a pointer on the display screen by the operation of the pointing device such as remote controller or mouse and, thereafter, clicks an area designation button 121, so that the designated range is extracted. Not only the area of a part of the Web page but also an area of the whole displayed Web page can be designated. In this case, by clicking a whole designation button 122, the whole area of the Web page 110 is extracted. By clicking a “next” button 123, the process advances to a process of a display setting part 24, which will be described hereinafter. An end button 124 is used to interrupt those processes.

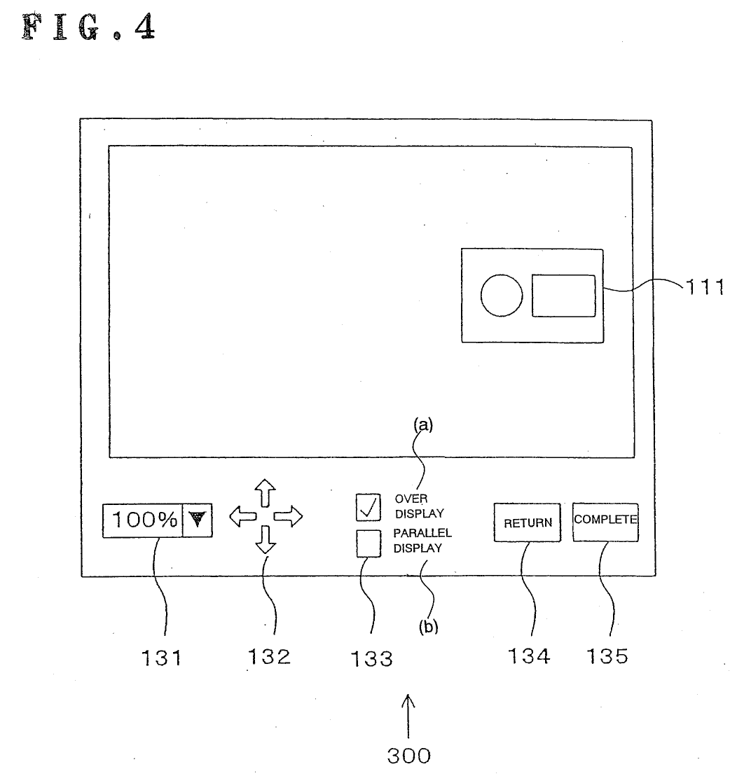

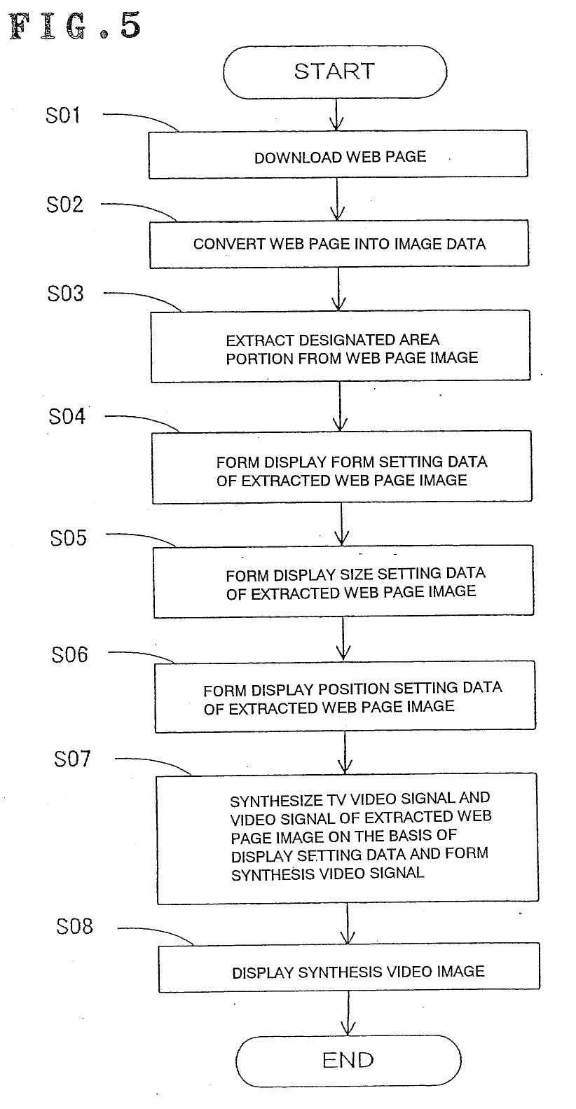

The display setting part 24 is a part that performs the setting of a display form of the image of a part of or whole Web page extracted by the process of the image extracting part 23, a setting of a display size, and a setting of a display position on the monitor 26. Specifically, as shown in FIG. 4, the image of the designated area 111 of the Web page extracted by the process of the image extracting part 23 is displayed. Further, a display setting display screen 300 using the GUI as operation input means 21 for setting the display form, display size, and display position with respect to the designated area 111 is displayed on the monitor 26.

A display size setting window 131 is used to set the display size of the image 111 of the extracted Web page. The display size is set by directly entering a magnification ratio to the window 131 or selecting the magnification ratio displayed by a pull-down menu system, or the display size may be changed by matching a position of a pointer to a corner portion of the extracted image 111 by the operation of the pointing device and executing a dragging operation.

A moving cursor 132 is used to move the extracted image 111 to an arbitrary position on the monitor 26. By clicking a button having an arrow shape indicative of a moving direction, the extracted image 111 can be moved to a desired position, or the display position may be moved by matching the position of the pointer to the extracted image 111 by the operation of the pointing device and executing the dragging operation.

A check box 133 is used to select the display form of the extracted image 111. Either “overlap display” or “parallel display” is selected by clicking the check box by the remote controller, mouse, or the like. The “overlap display” indicates a display form in which the image of the extracted Web page is overlaid and displayed onto the display screen of the television video image. The “parallel display” indicates a display form in which the display screen of the television video image and the image of the extracted Web page are displayed to the left and right in parallel. It is also possible to construct in such a manner that when the “parallel display” is selected, the foregoing operation for setting the display position is not executed.

By clicking a complete button 135 after completion of those settings, the display setting is completed. The display setting part 24 supplies display setting data showing the display size, display position, and display form which is formed by the processes to the video synthesizing part 25 together with the video signal of the image extracted from the Web page. A “return” button 134 is used to interrupt the display setting process and shift to the display area designation display screen 200 in FIG. 3 mentioned above.

The video synthesizing part 25 executes a synthesizing process of the video signal of the television broadcasting supplied from the video processing part 13 and the video signal of the Web page supplied from the display setting part 24. At the time of the synthesizing process, the synthesizing process is executed on the basis of display setting data which is supplied from the display setting part 24. A synthesized video signal synthesized by the process of the video synthesizing part 25 is supplied to the monitor 26.

The monitor 26 reproduces the synthesized video signal supplied from the video synthesizing part 25 and displays the synthesis video image.

Subsequently, the operation of the video display apparatus with the foregoing construction will be described with reference to a flowchart shown in FIG. 5.

When the user transmits an instruction to the video display apparatus in order to start a search for the Web page by the operation of a remote controller button (not shown) or the like, the Web page selection screen 100 shown in FIG. 2 is displayed on the monitor 26. When the user directly enters the URL or selects the URL of the Web page to be browsed from the registered URL list 103, the Web browser 22 downloads the relevant Web page from a Web server (not shown) on the network through the network 30 (step S01).

Subsequently, the image extracting part 23 executes a process for converting the downloaded web page from the HTML format into data in an image file format such as a bit map (step S02). As shown in FIG. 3, the display area designation display screen 200 is displayed on the monitor 26 together with the image of the Web page which has been data-converted into the image file. When the user executes the area designating operation of the portion to be displayed on the monitor 26 in the downloaded web page by the operation of the display area designation display screen 200, the image extracting part 23 extracts the image of the relevant portion on the basis of the operation (step S03). Subsequently, when the user clicks the “next” button 123 on the display area designation display screen 200, the image extracting part 23 supplies the image data of the extracted portion to the display setting part 24.

Subsequently, the display setting display screen 300 shown in FIG. 4 is displayed on the monitor 26. When the user selects either the “overlap display” or the “parallel display” on the display setting display screen 300, the display setting part 24 forms display form setting data showing a display form of the Web page image extracted in step S03 on the basis of it (step S04).

Subsequently, when the user designates the magnification ratio of the extracted Web page image by the operation of the display setting display screen 300, the display setting part 24 forms display size setting data showing a display size of the extracted Web page image on the basis of it (step S05). At this time, since the extracted image of the Web page which has been enlarged or reduced to the designated size is displayed on the monitor 26, the user can monitor and confirm a degree of the set image size.

Subsequently, when the user designates the display position of the extracted Web page image by the operation of the display setting display screen 300, the display setting part 24 forms display position setting data showing a display position of the extracted Web page image on the basis of it (step S06). In the step of the setting operation of the display position, the user can actually move the extracted image and can designate the display position while looking at it.

After completion of those display settings, when the user clicks the complete button 135 on the display setting display screen 300, the display setting part 24 supplies the display setting data constructed by the display form setting data, display size setting data, and display position setting data formed by the processes of steps S04 to S06 to the video synthesizing part 25 together with the video signal of the extracted Web page image.

Subsequently, the video synthesizing part 25 executes the synthesizing process of the video signal of the television broadcasting received from the video processing part 13 and the video signal of the Web page image received from the display setting part 24 on the basis of the display setting data and forms the synthesized video signal (step S07). That is, the video synthesizing part 25 executes the synthesizing process with the television video image so as to be displayed in the display form, display size, and display position designated with respect to the image extracted from the Web page. The video synthesizing part 25 supplies the synthesized video signal to the monitor 26.

The monitor 26 reproduces the received synthesized video signal and displays the synthesis video image onto the display screen. The image extracted from the Web page is, thus, displayed on the display screen of the monitor 26 in the designated size and at the designated position together with the television video image (step S08).

FIG. 6 is a diagram showing an example of a display screen of the synthesis video image generated onto the monitor 26 in the case where the “overlap display” has been selected on the GUI display screen of FIG. 4. The extracted image 111 of the Web page is displayed on a television video display screen 141 (main image) in the display size and the display position set by the display setting part 24.

As will be obvious from the above explanation, according to the video display apparatus of the embodiment, the arbitrary area is extracted from the Web page downloaded from the network such as Internet and can display in an arbitrary size and an arbitrary position simultaneously with the main image such as a television video image. The unnecessary portions shown on the Web page, therefore, are not displayed and the size and display position of the image can be freely set. The downloaded Web page is converted from the HTML format into the image data, so that the area which can be extracted can be freely set without being subjected to a restriction due to the tag. Further, the portion to be displayed can be extracted and the display size, display position, and display form can be set by using the GUI. The user can set them while looking at the display image in those settings and the excellent operability is obtained.

### Embodiment 2

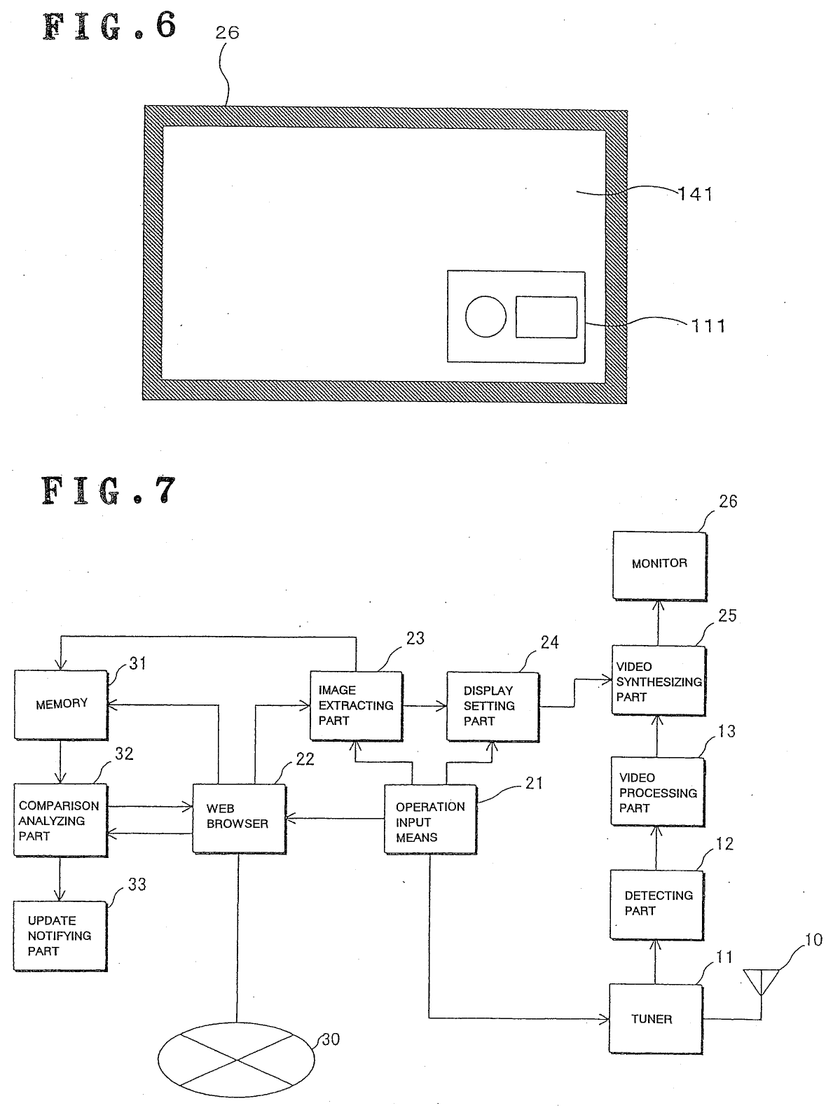

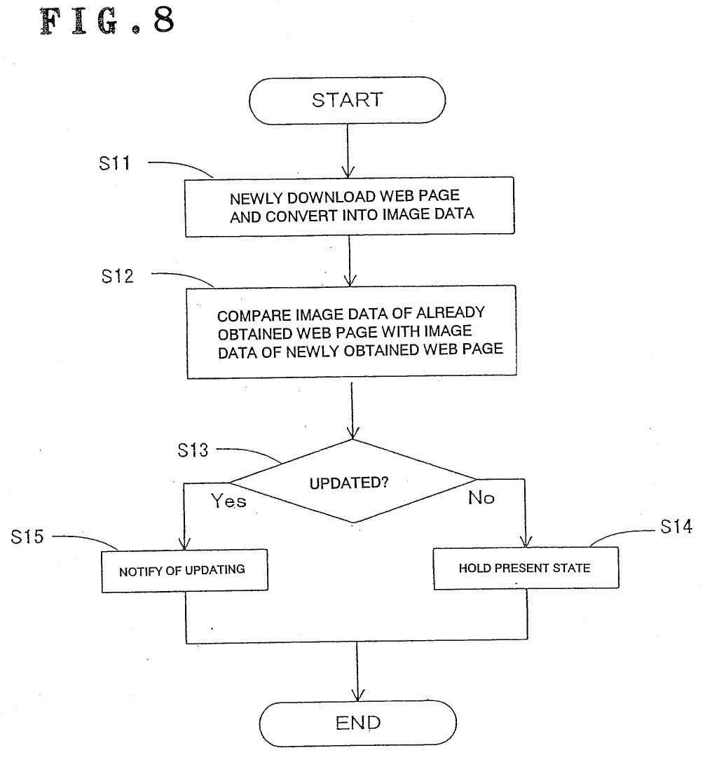

Subsequently, the second embodiment of the invention will be described with reference to FIGS. 7 and 8. FIG. 7 is a diagram showing a whole construction of a video display apparatus according to the second embodiment of the invention. In addition to the construction of the first embodiment, the second embodiment has a construction including means constructed in such a manner that when a Web page as a supplying source of the Web page image displayed at present on the display screen of the monitor 26 is updated, its updating is detected and the user is notified that the updating has been performed. Portions different from the first embodiment will be described below.

A memory 31 holds URL information of the Web page as a supplying source of the Web page image displayed at present on the display screen of the monitor 26. As display information for displaying the Web page, the memory 31 also holds the image data of the whole Web page at the time when the Web page has been obtained. That is, the Web page converted into the image data by the image extracting part 23 is held in the memory 31.

A comparison analyzing part 32 transmits a download request signal of the Web page as a supplying source of the Web page image displayed at present on the display screen of the monitor 26 to the Web browser 22 every predetermined period (for example, one hour). At this time, the comparison analyzing part 32 reads the URL information of the Web page held in the memory 31 and also simultaneously transmits it to the Web browser 22. In response to it, the Web browser 22 newly downloads the Web page through the network 30 every predetermined period.

The comparison analyzing part 32 also reads the image data as display information of the Web page which had already been obtained from the memory 31, compares it with the image data of the Web page which has newly been obtained, and discriminates whether or not the contents of the Web page have been updated. That is, the presence or absence of the updating can be detected by discriminating whether or not they coincide at a level of pixel data constituting the image data of both of them, that is, at a bit data level. If the image data of both of them does not completely coincide, the comparison analyzing part 32 determines that the Web page has been updated, and transmits an activation signal toward an update notifying part 33.

When the activation signal supplied from the comparison analyzing part 32 is received, the update notifying part 33 notifies the user that the Web page has been updated. Specifically speaking, the update notifying part 33 makes a notification of the updating by means which is recognized through the sense of sight or the sense of hearing of the user, such as display of characters, symbol, or picture on the display screen of the monitor 26, display by an LED or a sub-display provided outside of the monitor, or warning by a sound from a speaker, a buzzer, or the like.

Subsequently, the operation in which the video display apparatus according to the second embodiment having the foregoing construction detects the updating of the Web page and notifies of it will be described with reference to a flowchart shown in FIG. 8. It is now assumed that as an initial state, the processes of steps S01 to S07 in the flowchart shown in FIG. 5 have been completed and the image extracted from the Web page designated by the user and the video image of the television broadcasting have been synthesized and displayed on the display screen of the monitor 26.

The comparison analyzing part 32 transmits the download request signal of the Web page as a supplying source of the image displayed at present on the display screen of the monitor 26 to the Web browser 22 every predetermined period (for example, one hour) together with the URL information read out of the memory 31. The Web browser 22 which received the download request signal newly downloads the relevant Web page through the network 30 and converts it into the image data (step S11).

Subsequently, the comparison analyzing part 32 reads the image data of the Web page which had already been obtained and held in the memory 31 and compares it with the image data of the Web page which has newly been obtained in step S11 (step S12). The image data of the Web page which had already been obtained is held in the memory 31 when the relevant Web page is converted into the image data, that is, after step S02 in the flowchart of FIG. 5.

The comparison analyzing part 32 compares the pixel data with respect to both of the image data and discriminates the presence or absence of the updating of the Web page by checking whether or not they perfectly coincide (step S13).

As a result of the comparison of both of the image data, if it is detected that they perfectly coincide with respect to all pixel data constituting those images, the comparison analyzing part 32 determines that the Web page is not updated (NO in step S13), and holds the present state as it is (step S14).

As a result of the comparison of both of the image data, if it is detected that they do not perfectly coincide with respect to all pixel data constituting those images, the comparison analyzing part 32 determines that the Web page has been updated (YES in step S13), and transmits the activation signal toward the update notifying part 33. When the activation signal is received, the update notifying part 33 notifies the user that the Web page has been updated by a display, a voice, or the like of a message such as “Web page has been updated” on the display screen of the monitor 26 (step S15).

As will be obvious from the above explanation, according to the video display apparatus of the second embodiment, if the contents of the Web page as a supplying source of the image displayed at present on the display screen of the monitor 26 has been updated, the user can be notified that the Web page has been updated. The user can promptly cope with an irregular updating of the Web page.

In the embodiment, in the image of the Web page which had already been obtained and the image of the Web page which has newly been obtained, the comparison is made with respect to the pixel data constituting those image data, and the presence or absence of the updating of the Web page is discriminated by checking whether or not the pixel data completely coincides. The invention, however, is not limited to it. For example, by measuring the number of pixels in the portion where the pixel data coincides in both of the images and the number of pixels in the portion where the pixel data does not coincide, a change ratio can be obtained. Whether or not the Web page has been updated can be also discriminated in accordance with the change ratio. Specifically speaking, a threshold value is provided with respect to the change ratio of the pixel data of both of the images and the presence or absence of the updating can be discriminated by checking whether the change ratio is larger or less than the threshold value. For example, when the change ratio of the pixel data is less than 10%, the absence of the updating is decided. When the change ratio of the pixel data is equal to or larger than 10%, the presence of the updating is determined.

### Embodiment 3

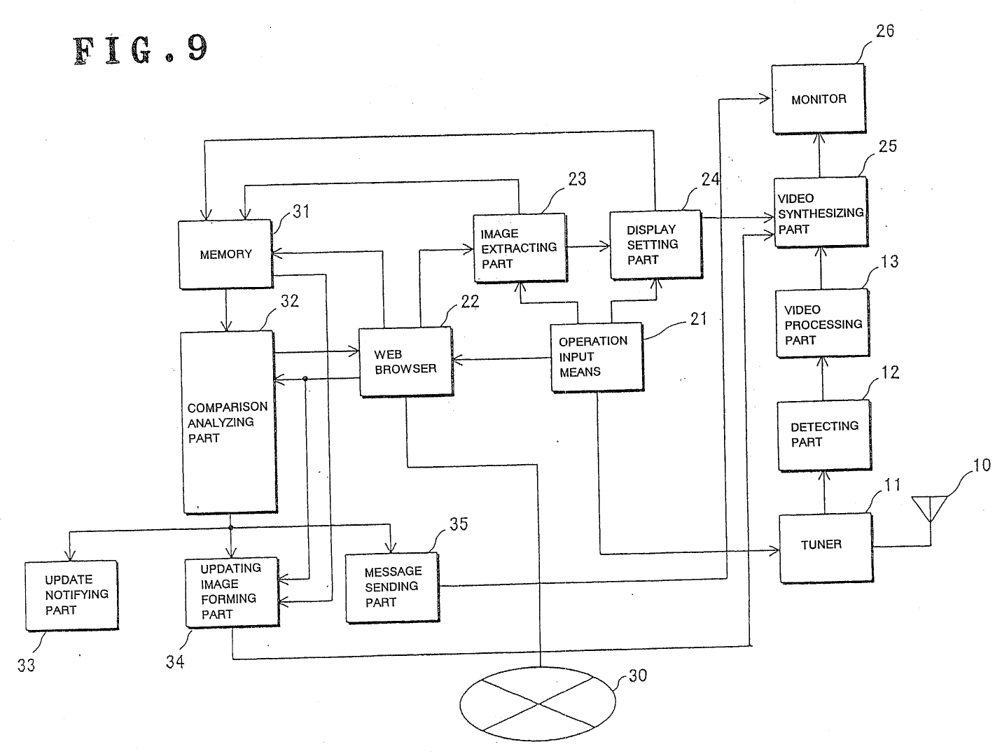

Subsequently, the third embodiment of the invention will be described with reference to FIGS. 9 to 11. FIG. 9 is a diagram showing a whole construction of a video display apparatus according to the third embodiment of the invention. The third embodiment has a construction including means for detecting the presence or absence of the updating of the Web page by analyzing the HTML document, notifying the user that the Web page has been updated, and executing a predetermined countermeasure in accordance with a state of a change in the Web page due to the updating. Portions different from the first and second embodiments will be described hereinbelow.

The memory 31 holds the URL information of the Web page as a supplying source of the Web page image displayed at present on the display screen of the monitor 26. From the Web browser 22, the memory 31 fetches display information necessary to construct and display a Web page such as document, image, and hyper link disclosed in the relevant Web page, and structure, layout, and the like of the Web page and holds the display information. That is, an HTML, XHTML, or the like can be mentioned as a markup language for describing the Web page. The memory 31 holds, for example, tag information of HTML or XHTML as display information.

Further, the display information also includes tag information of an extracting portion showing to which portion in the display information the tag corresponding to the extracting portion of the Web page displayed at present on the display screen of the monitor 26 corresponds. The tag information of the extracting portion is recorded in the memory 31 as additional information of the display information when the image extracting part 23 executes the extracting process of the display area in the step of the displaying process of the image displayed at present on the display screen of the monitor 26.

The memory 31 reads extracting position data showing the position and extracting area in the whole Web page of the extracting portion of the Web page image displayed at present on the display screen of the monitor 26 from the image extracting part 23 and holds the extracting position data. That is, the extracting position data is data showing which portion in the Web page in which range has been extracted. The position in the whole Web page of the extracted image can be expressed by, for example, coordinates in which a predetermined position of the Web page is set to a reference point. By using the coordinates, the extracting area can be expressed by coordinates of two points on a diagonal line of the extracted image area and it can be used as extracting position data.

The memory 31 reads display setting data including the display size setting data, display position setting data, and display form setting data formed by the display setting part 24 in the display setting process of the Web page displayed at present on the display screen of the monitor 26 from the display setting part 24 and holds the display setting data.

The comparison analyzing part 32 transmits the download request signal of the Web page as a supplying source of the Web page image displayed at present on the display screen of the monitor 26 to the Web browser 22 every predetermined period (for example, one hour). At this time, the comparison analyzing part 32 reads the URL information of the Web page held in the memory 31 and also simultaneously transmits it to the Web browser 22. In response to it, the Web browser 22 newly downloads the Web page through the network 30 every predetermined period.

The comparison analyzing part 32 also reads the display information showing the structure, contents, and the like of the Web page which had already been obtained from the memory 31, compares it with the display information of the Web page which has newly been obtained, and discriminates whether or not the contents of the Web page have been updated. The presence or absence of the updating is discriminated by analyzing the tags of both of the Web pages and detecting the presence or absence of the change with respect to the structure and layout of the Web page and the document, image, and the like disclosed in the Web page.

Further, the comparison analyzing part 32 analyzes a state of the change in the structure and contents of the Web page caused by the Web page updating and selects a countermeasure according to a result of the analysis. Specifically, in accordance with the state of the change in the Web page, with respect to the image of the Web page displayed at present on the display screen of the monitor 26, one of the following countermeasures is selected: 1. the display of the image is held as it is; 2. the image of the display portion is replaced by the updated new contents; and 3. a notification that the resetting of the extracting area of the Web page should be made is performed.

A method of analyzing the state of the change in the Web page by the comparison analyzing part 32 and a method of selecting one of the countermeasures 1 to 3 according to the analysis result will be described hereinbelow. The following (a) to (d) show types of states of changes due to the updating of the Web page. The comparison analyzing part 32 analyzes to which one of those types the change corresponds.

(a) The case where the structures of the Web pages are the same and there are no changes in contents of all tags, that is, the case where the Web page is not updated.

(b) The case where the structures of the Web pages are the same and although there is no change in contents of the tag corresponding to the extracting portion of the Web page displayed at present on the display screen of the monitor 26, there are changes in other portions.

(c) The case where the structures of the Web pages are the same and there is a change in contents of the tag corresponding to the extracting portion of the Web page displayed at present on the display screen of the monitor 26.

(d) The case where there is a change in structure of the Web page.

The discrimination about whether or not the structures of the Web pages are the same is made by comparing the kinds, the number, and the order of the tags. The tag information corresponding to the extracting portion of the Web page displayed at present on the display screen of the monitor 26 has been held as additional information of the display information in the memory 31. The tag information is compared with the contents of a tag of a newly obtained Web page corresponding to the tag information, thereby detecting whether or not there is a change in contents of the tag corresponding to the extracting portion.

Subsequently, the comparison analyzing part 32 selects one of the countermeasures 1 to 3 on the basis of the analysis result about the types of states of the changes of (a) to (d).

When the change state falls under (a) or (b), the structure of the Web page does not change and no changes occur with respect to the extracting portion from the Web page displayed at present on the display screen of the monitor 26. The comparison analyzing part 32, therefore, selects the countermeasure adapted to hold the display of the image as it is (corresponding to the countermeasure of 1). In the case falling under (b), however, although there is no change with respect to the extracting portion displayed at present on the display screen of the monitor 26, since the changes have occurred in the other portions, the comparison analyzing part 32 transmits the activation signal toward the update notifying part 33.

In the case falling under (c), although the change has occurred in the extracting portion from the Web page displayed at present on the display screen of the monitor 26, since the structure of the Web page does not change, the relevant extracting portion can be traced in the updated new Web page. In this case, the comparison analyzing part 32 selects the countermeasure adapted to execute a process for replacing the image of the extracting portion by the updated new Web page (corresponding to the countermeasure of 2). In the case falling under (c), the comparison analyzing part 32 transmits the activation signal toward the update notifying part 33 and an updating image forming part 34.

In the case falling under (d), since the structure of the Web page has changed, the extracting portion of the Web page displayed at present on the display screen of the monitor 26 cannot be traced in the updated Web page. In the case, the comparison analyzing part 32 selects the countermeasure adapted to generate an instruction to reset the extracting area (corresponding to the countermeasure of 3). In the case falling under (d), the comparison analyzing part 32 transmits the activation signal toward the update notifying part 33 and a message sending part 35.

If it is detected by the comparison analyzing part 32 that the Web page has been updated, that is, in the case falling under (b), (c), or (d) among the types of states of the changes mentioned above, on the basis of the activation signal supplied from the comparison analyzing part 32, the update notifying part 33 notifies the user that the Web page has been updated. Specifically speaking, the update notifying part 33 makes a notification of the updating by means which is recognized through the sense of sight or the sense of hearing of the user, such as display of characters, symbol, picture, or the like on the display screen of the monitor 26, display by an LED or a sub-display provided outside of the monitor, or warning by a sound from a speaker, a buzzer, or the like.

If it is determined by the comparison analyzing part 32 that the change state corresponds to (c) among the types of states of the changes mentioned above, that is, in the case where the structures of the Web pages are the same and there is a change in contents of the tag corresponding to the extracting portion of the Web page displayed at present on the display screen of the monitor 26, on the basis of the activation signal supplied from the comparison analyzing part 32, the updating image forming part 34 converts the updated new Web page into the image data and extracts the portion corresponding to the extracting portion. In the extracting process, the updating image forming part 34 reads the extracting position data held in the memory 31 and executes the extracting process with respect to the new Web page on the basis of the extracting position data. That is, the updating image forming part 34 extracts the image in the same position and range as those of the extracting portion of the Web page image displayed at present on the display screen of the monitor 26 and forms an updating video signal. The updating image forming part 34 further reads the display setting data held in the memory 31 and makes the display setting with respect to the new Web page image. That is, the updating image forming part 34 makes the same display setting as that of the display size, display position, and display form of the Web page image displayed at present on the display screen of the monitor 26 and forms display setting data on the basis of the display setting. The updating image forming part 34 transmits the updating video signal and the display setting data to the video synthesizing part 25.

If it is determined by the comparison analyzing part 32 that the change state falls under (d) among the types of states of the changes mentioned above, that is, in the case where there is a change in structure of the Web page, on the basis of the activation signal supplied from the comparison analyzing part 32, the message sending part 35 transmits message data adapted to reset the extracting area of the Web page image to the monitor 26. A message adapted to reset an extracting range of the Web page image is displayed on the monitor 26.

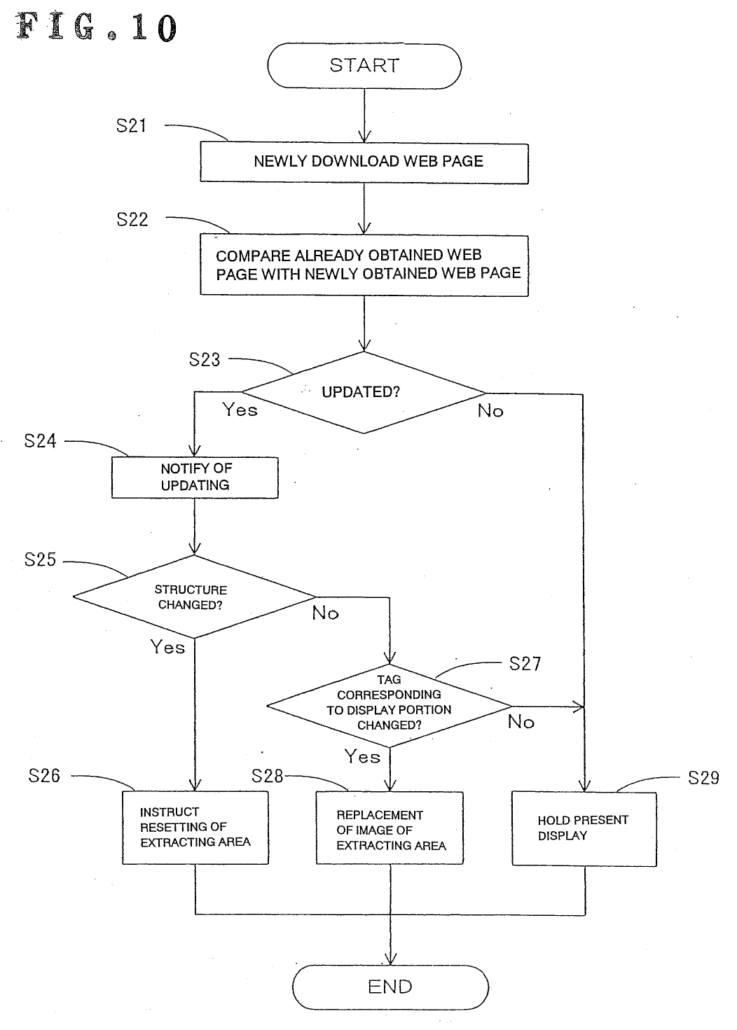

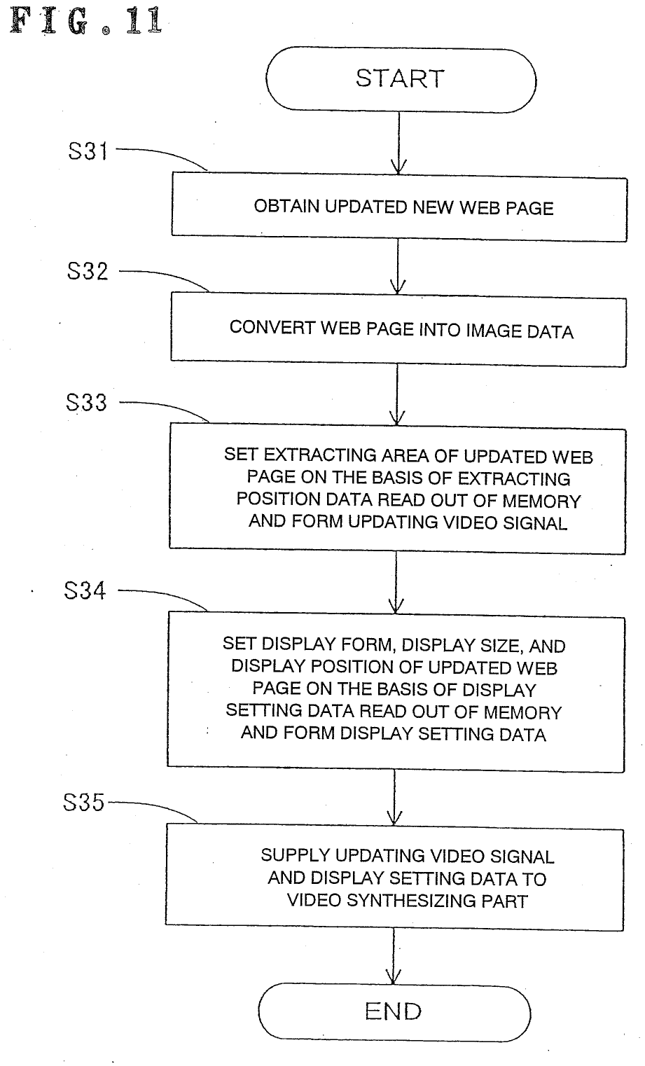

Subsequently, the operation in which the video display apparatus according to the third embodiment having the foregoing construction detects the updating of the Web page and performs the countermeasure according to the state of the change due to the updating will be described with reference to a flowchart shown in FIG. 10. As an initial state, it is assumed that the processes of steps S01 to S07 in the flowchart shown in FIG. 5 have been completed and the image extracted from the Web page designated by the user and the video image of the television broadcasting have been synthesized and displayed on the display screen of the monitor 26.

The comparison analyzing part 32 transmits the download request signal of the Web page as a supplying source of the image displayed at present on the display screen of the monitor 26 to the Web browser 22 together with the URL information read out from the memory 31 every predetermined period (for example, one hour). The Web browser 22 which received the download request signal newly downloads the Web page through the network 30 (step S21).

Subsequently, the comparison analyzing part 32 also reads the display information showing the structure, contents, and the like of the Web page which had been held in the memory 31 and had already been obtained therefrom and compares it with the display information of the Web page which has newly been obtained in step S21 (step S22). Specifically speaking, the tags of both of the Web pages are compared. The display information of the Web page which had already been obtained is held in the memory 31 when the relevant Web page has been downloaded, that is, after step S01 in the flowchart of FIG. 5.

The comparison analyzing part 32 compares the number, the kinds, and the order of the tags, the contents of the document and image, and the like and detects in which one of them the change has occurred, thereby discriminating the presence or absence of the updating of the Web page (step S23).

If it is determined that no changes occur in which one of the number, the kinds, and the order of the tags, and the character train or the number of characters in the tag, the comparison analyzing part 32 decides that the Web page is not updated (NO in step S23). The image of the Web page displayed at present on the display screen of the monitor 26 is displayed as it is (step S29).

If it is detected that the change has occurred in any of the number, the kinds, and the order of the tags, and the character train or the number of characters in the tag, the comparison analyzing part 32 decides that the Web page has been updated (YES in step S23), and transmits the activation signal to the update notifying part 33. In response to it, the update notifying part 33 notifies the user that the Web page has been updated by a display, a voice, or the like of a message such as “Web page has been updated” on the display screen of the monitor 26 (step S24).

Subsequently, if it is determined that the Web page has been updated, the comparison analyzing part 32 further discriminates whether or not there is a change in structure of the Web page (step S25). As for the structure of the Web page, the kinds, the numbers, and the order of the tags of both of the Web pages are compared and when there is a change in any one of them, it is decided that the structure has changed. When there are no changes in all of them, it is decided that the structure is not changed.

When it is decided that the structure of the Web page has changed due to the updating (YES in step S25), the comparison analyzing part 32 transmits the activation signal to the message sending part 35. In response to it, the message sending part 35 transmits the message data adapted to reset the extracting range of the Web page image to the monitor 26, so that a message such as “Reset display range of Web image” or the like is displayed on the display screen of the monitor 26 (step S26).

When it is determined that the structure of the Web page is not changed due to the updating (NO in step S25), the comparison analyzing part 32 reads the tag information corresponding to the extracting portion of the Web page displayed at present on the display screen of the monitor 26 from the memory 31, compares the tag information with the character train and the number of characters in the tag in the newly obtained Web page corresponding to the tag information, and discriminates whether or not the change has occurred in the contents of the tag (step S27).

The processing contents of step S27 mentioned above will be specifically explained. It is assumed that a specific image extracted from the Web page has been displayed on the display screen of the monitor 26. As tag information of the extracting portion, a tag <img src=“picture1.gif”> showing a display of an image file “picture1.gif” of the image has been held in the memory 31. The comparison analyzing part 32 reads the tag information of the extracting portion from the memory 31 and compares the tag information with the tag in the newly obtained Web page corresponding to the tag information. For example, in the newly obtained Web page, if the image is updated and the contents of the tag become, for example, <img src=“picture2.gif”>, it is detected from the contents held in the memory 31 that the change has occurred. The comparison analyzing part 32 determines that the change has occurred in the contents of the tag.

When it is determined by the process of step S27 that the change has occurred in the contents of the tag (YES in step S27), the comparison analyzing part 32 transmits the activation signal to the updating image forming part 34. In response to it, the updating image forming part 34 converts the Web page which has newly been downloaded in step S21 into the image data, makes the setting of the extracting area, display size, display position, and display form, forms the updating video signal and the display setting data, and transmits them to the video synthesizing part 25. The display size, display position, and display form are set to the same state as the state where they are displayed at present on the display screen of the monitor 26. In place of the Web page image displayed so far, the video synthesizing part 25 synthesizes the updating video signal and the video signal of the television broadcasting, forms a new synthesized video signal, and transmits it to the monitor 26. The monitor 26 reproduces the synthesized video signal and the updated Web image and the video image of the television broadcasting are simultaneously displayed on the display screen (step S28).

When the comparison analyzing part 32 determines by the process of step S27 that no change occurs in the contents of the tag (NO in step S27), the Web page image displayed at present on the display screen of the monitor 26 is displayed as it is (step S29).

Subsequently, processes which are executed by the updating image forming part 34 in the process of step S28 in the flowchart of FIG. 10 will be described hereinbelow with reference to a flowchart of FIG. 11.

In response to the activation signal transmitted from the comparison analyzing part 32, the updating image forming part 34 obtains the updated new Web page from the Web browser 22 (step S31).

Subsequently, the updating image forming part 34 executes a data converting process for converting the new Web page obtained in step S31 from the HTML format into the data in the image file format such as a bit map (step S32).

Subsequently, the updating image forming part 34 reads the extracting position data from the memory 31, designates the extracting area on the basis of the extracting position data with respect to the updated new Web page, and forms the updating video signal (step S33). That is, the position and range of the portion which is extracted from the Web page after the updating by the process are the same as the position and range of the extracting portion of the Web page image before the updating in terms of the coordinate level. The extracting position data is held in the memory 31 when the image extracting part 23 has extracted the display area, that is, after step S03 in the flowchart of FIG. 5 in the processing step of the image displayed at present on the display screen of the monitor 26.

Subsequently, the updating image forming part 34 reads the display setting data including the display size setting data, display position setting data, and display form setting data of the image displayed at present on the display screen of the monitor 26 from the memory 31, makes the setting of the display size, display position, and display form with respect to the extracting portion of the new Web page on the basis of the display setting data, and forms display setting data (step S34). That is, by this process, the state of the display size, display position, and display form of the image displayed at present on the display screen of the monitor 26 is held as it is. The display setting data is held in the memory 31 when the display setting in the display setting part 24 is completed, that is, after step S06 in the flowchart of FIG. 5 in the processing step of the image displayed at present on the display screen of the monitor 26.

By the process described above, the updating video signal and the display setting data are formed and the updating image forming part 34 supplies it to the video synthesizing part 25 (step S35).

On the basis of the display setting data, in place of the image displayed so far, the video synthesizing part 25 executes the synthesizing process of the updating video signal and the video signal of the television broadcasting, forms a new synthesized video signal, and transmits it to the monitor 26. The monitor 26 reproduces and displays the new synthesized video signal.

As will be obvious from the above description, according to the video display apparatus of the third embodiment, if the contents of the Web page as a supplying source of the image displayed at present on the display screen of the monitor 26 have been updated, the user can be notified that the updating has been performed. Further, since a countermeasure according to the state of the change in Web page due to the updating is made, a burden of the operation of the user accompanied by the updating of the Web page can be reduced. That is, even when the Web page has been updated, if there is no change with respect to the portion displayed at present on the display screen of the monitor 26, the present image is displayed as it is. The user, therefore, doesn't need to operate anything. In the case where there is no change in structure of the Web page and there is an updating with respect to the portion displayed at present on the screen of the monitor 26, since a process for replacing the image by the updated image is executed, the user doesn't need to operate anything with respect to the above case. When there is a change in structure of the Web page, since the message adapted to reset the display area is displayed on the display screen, the user can cope with it on the basis of the message.

Although the case where the television video image is used as a main image has been shown in the first to third embodiments, the invention is not limited to it. For example, the main image may be the Web page image.

1. A video display apparatus comprising: first video signal generating means for generating a first video signal; second video signal generating means for generating a second video signal different from said first video signal; video signal synthesizing means for synthesizing said first video signal and said second video signal to generate a single synthesized video signal; and display means for reproducing and displaying any one of said first video signal, said second video signal, and said synthesized video signal,
wherein said second video signal generating means includes
Web page obtaining means, connected to a network, for obtaining a Web page through said network,
data converting means for converting said Web page into image data,
extracting means for extracting a designated area from the Web page converted into the image data,
display size setting means for setting a Web page image in said designated area to a designated display size, and
display position setting means for setting a display position of the Web page image in said designated area,
said video signal synthesizing means generates the synthesized video signal based on said designated display size setting and said display position setting, and
said second video signal generating means further includes
storing means for holding display information of the Web page obtained by said Web page obtaining means,
page update obtaining means for obtaining a new Web page from a supplying source of said Web page every predetermined period,
comparing means for comparing the display information of said Web page held in said storing means with display information of said new Web page and discriminating the presence or absence of the updating of said Web page, and
update notifying means for notifying of said updating when said comparing means determines the presence of the updating.

2. A video display apparatus according to claim 1, wherein said video signal synthesizing means executes a synthesizing process that overlays a second video image based on said second video signal on a first video image based on said first video signal when displaying.

3. A video display apparatus according to claim 1, wherein said first video signal is a television video signal.

4. (canceled)

5. A video display apparatus according to claim 1, wherein said display information is the image data showing an external appearance of the Web page and said comparing means compares pixel data constituting the image data of said Web page and discriminates the presence or absence of the updating of said Web page.

6. A video display apparatus according to claim 1, wherein said display information is tag information of an HTML describing the Web page.

7. A video display apparatus according to claim 6, wherein said comparing means compares an HTML document of said Web page with an HTML document of said new Web page and determines that said Web page has been updated when it is detected that there is a difference in any one of the number, kinds, and order of tags, and a character train or the number of characters in the tag.

8. A video display apparatus according to claim 7, further comprising change instructing means for allowing an indication which should change said designated area to be displayed to said display means when it is determined by said comparing means that said Web page has been updated and it is detected that there is the difference between said Web page and any one of the number, kinds, and order of the tags of said new Web page.

9. A video display apparatus according to claim 7, wherein said apparatus further comprises updating video signal generating means for extracting a same portion as said designated area from said new Web page and forming an updating video signal when it is determined by said comparing means that said Web page has been updated and it is detected that there is no difference between said Web page and any one of the number, kinds, and order of the tags of said new Web page and that there is the difference in the character train or the number of characters in said tag, and
said video signal synthesizing means synthesizes said updating video signal and said first video signal and forms a new synthesized video signal.

10. A video display method comprising:
a first video signal generating step of generating a first video signal; a second video signal generating step of generating a second video signal different from said first video signal; a video signal synthesizing step of synthesizing said first video signal and said second video signal to generate a single synthesized video signal; and a display step of reproducing and displaying any one of said first video signal, said second video signal, and said synthesized video signal,
wherein said second video signal forming step includes
a Web page obtaining step of obtaining a Web page through a network,
a data converting step of converting said Web page into image data,
an extracting step of extracting a designated area from the Web page converted into the image data,
a display size setting step of setting a Web page image in said designated area to a designated display size, and
a display position setting step of setting a display position of the Web page image in said designated area,
in said video signal synthesizing step, the synthesized video signal is generated based on said designated display size setting and said display position setting, and
said second video signal forming step includes
a step of holding display information of the Web page obtained by said Web page obtaining step into storing means,
a step of obtaining a new Web page from a supplying source of said Web page every predetermined period,
a comparing step of comparing the display information of said Web page held in said storing means with display information of said new Web page and discriminating the presence or absence of the updating of said Web page, and
an update notifying step of notifying of said updating when the presence of the updating is determined in said comparing step.

11. A video display method according to claim 10, wherein said video signal synthesizing step performs a synthesizing process that overlays a second video image based on said second video signal onto a first video image based on said first video signal when displaying.

12. A video display method according to claim 10, wherein said first video signal is a television video signal.

13. (canceled)

14. A video display method according to claim 10, wherein said display information is the image data showing an external appearance of the Web page and
in said comparing step, pixel data constituting the image data of said Web page is compared and the presence or absence of the updating of said Web page is discriminated.

15. A video display method according to claim 10, wherein said display information is tag information of an HTML describing the Web page.

16. A video display method according to claim 15, wherein in said comparing step, an HTML document of said Web page is compared with an HTML document of said new Web page and when it is detected that there is a difference in any one of the number, kinds, and order of tags, and a character train or the number of characters in the tag, it is determined that said Web page has been updated.

17. A video display method according to claim 16, further comprising a step of allowing an indication which should change said designated area to be displayed when it is determined in said comparing step that said Web page has been updated and it is detected that there is the difference between said Web page and any one of the number, kinds, and order of the tags of said new Web page.

18. A video display method according to claim 16, wherein in said comparing step, when it is determined that said Web page has been updated and it is detected that there is no difference between said Web page and any one of the number, kinds, and order of the tags of said new Web page and that there is the difference in the character train or the number of characters in said tag, a same portion as said designated area is extracted from said new Web page, an updating video signal is formed, and said updating video signal and said first video signal are synthesized, and a new synthesized video signal is formed.

19. A video display apparatus according to claim 2, wherein said first video signal is a television video signal.

20. A video display apparatus according to claim 8 wherein said apparatus further comprises updating video signal generating means for extracting a same portion as said designated area from said new Web page and forming an updating video signal when it is determined by said comparing means that said Web page has been updated and it is detected that there is no difference between said Web page and any one of the number, kinds, and order of the tags of said new Web page and that there is the difference in the character train or the number of characters in said tag, and
said video signal synthesizing means synthesizes said updating video signal and said first video signal and forms a new synthesized video signal.

21. A video display method according to claim 17, wherein in said comparing step, when it is determined that said Web page has been updated and it is detected that there is no difference between said Web page and any one of the number, kinds, and order of the tags of said new Web page and that there is the difference in the character train or the number of characters in said tag, a same portion as said designated area is extracted from said new Web page, an updating video signal is formed, and said updating video signal and said first video signal are synthesized, and a new synthesized video signal is formed.
